(19) United States
(12) Patent Application Publication
(10) Pub. No.: US 2003/0082027 A1
(43) Pub. Date: May 1, 2003

(54) Screw for fibrous boards

(76) Inventor: Chao Wei Lin, Tainan City (TW)

Correspondence Address: Finnegan, Henderson, Farabow, Garrett & Dunner, L.L.P., 1300 I Street, N.W., Washington, DC, 20005-3315, US

(21) Appl. No.: 10/127,730

(22) Filed: Apr. 23, 2002

(30) Foreign Application Priority Data
Oct. 25, 2001 (TW) 090217526
Nov. 28, 2001 (CN) 01266358.1

(51) Int. Cl. F16B 25/10

(52) U.S. Cl. 411/387.1

(57) ABSTRACT

A screw includes a shank having a head end part, a tapered insert end part, and a surface that is formed with a screw thread that spirals downwardly along an axis of the shank. The insert end part has a surface formed with a flute. The flute has an upper end portion that extends to interrupt a portion of the screw thread, and is defined by two confining side walls which extend radially from the axis of the shank and which form an angle ranging from 90° to 180° therebetween. The upper and lower end portions of the flute have a depth that gradually increases toward an intermediate portion of the flute.

### BACKGROUND OF THE INVENTION

1. Field of the Invention

The invention relates to a screw, more particularly to a screw for fibrous boards.

2. Description of the Related Art

Referring to FIG. 1, a conventional screw 1 is shown to comprise a shank 12 having a head end part 11, a tapered insert end part 13 opposite to the head end part 11 along an axis (X) of the shank 12, and a surface that is formed with a screw thread 132 that spirals downwardly along the axis (X) of the shank 12 from one end of the shank 12 which is adjacent to the head end part 11 to the insert end part 13.

In use, after abutting the insert end part 13 of the screw 1 against a wooden board 2, a torque is applied on the head end part 11. The insert end part 13 and the screw thread 132 will be driven directly and rotatably into the wooden board 2 without having to bore a hole initially in the wooden board 2.

To cope with the diminishing number of trees in forests, a fibrous board which makes use of recyclable materials, such as wood shavings, chemical fiber, and plastic materials, has been proposed heretofore. These recyclable materials are pressed under high temperature to produce the fibrous board that is substantially similar to a wooden board in appearance. However, unlike the wooden board, the fibrous board has no interlaced wood fibers, and thus has a relatively weak binding force with a screw. If the conventional screw 1 is driven directly into the fibrous board (not shown), driving movement of the screw thread 132 can cause the surface of the fibrous board to crack easily, thereby further weakening the binding force with the screw 1, and thereby damaging the appearance of the fibrous board. To use the conventional screw 1 on the fibrous board without damaging the surface of the latter, a boring machine (not shown) has to be used so as to bore a hole in the fibrous board before the screw 1 is driven into the board. However, this method is very troublesome and complicated.

### SUMMARY OF THE INVENTION

Therefore, the main object of the present invention is to provide a screw that can be fastened directly into the fibrous board without damaging the surface of the latter.

Accordingly, a screw of the present invention comprises a shank having a head end part and a tapered insert end part opposite to the head end part along an axis of the shank. The shank further has a surface that is formed with a screw thread that spirals downwardly along the axis of the shank from one end of the shank which is adjacent to the head end part to the other end of the shank which is adjacent to the insert end part. The insert end part is formed with an insert tip, and has a surface formed with a flute. The flute has an upper end portion and a lower end portion. The upper end portion extends to interrupt a portion of the screw thread. The lower end portion is opposite to the upper end portion. The flute is defined by two confining side walls which extend radially from the axis of the shank and which form an angle ranging from 90° to 180° therebetween. The upper and lower end portions of the flute have a depth that gradually increases toward an intermediate portion of the flute.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional screw;

FIG. 2 is a perspective view of the first preferred embodiment of a screw according to the present invention;

FIG. 3 is a fragmentary sectional view of the first preferred embodiment;

FIGS. 4A and 4B are fragmentary schematic views illustrating pointed and rounded insert tips of the screw of FIG. 2;

FIG. 5 is a schematic view of the screw of FIG. 2 before being driven into a fibrous board;

FIG. 6 is another schematic view of the screw of FIG. 2 illustrating an insert end part of the screw when driven into the fibrous board; and

FIG. 7 is a perspective view of the second preferred embodiment of a screw according to the present invention.

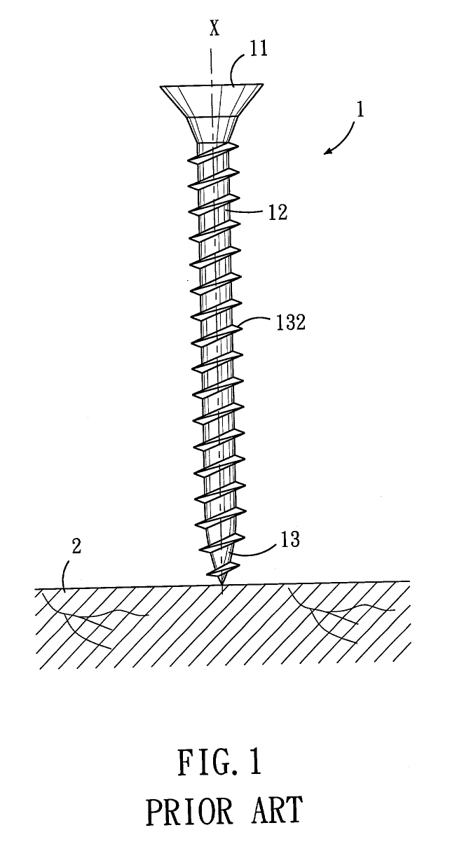

### DETAILED DESCRIPTION OF THE PREFERRED EMBODIMENTS

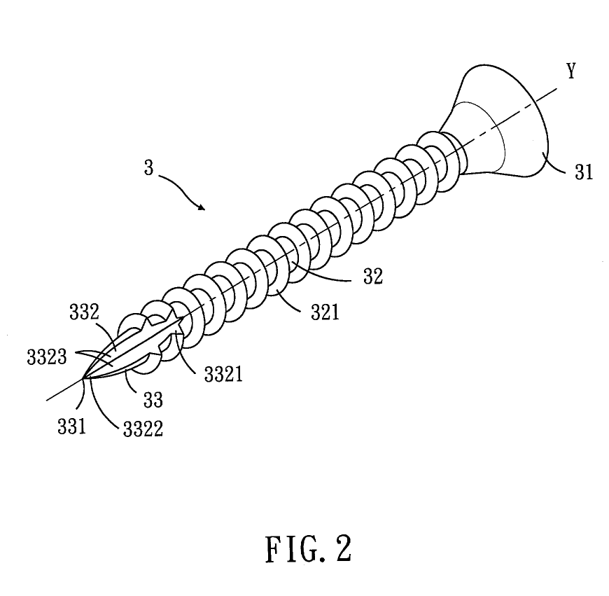

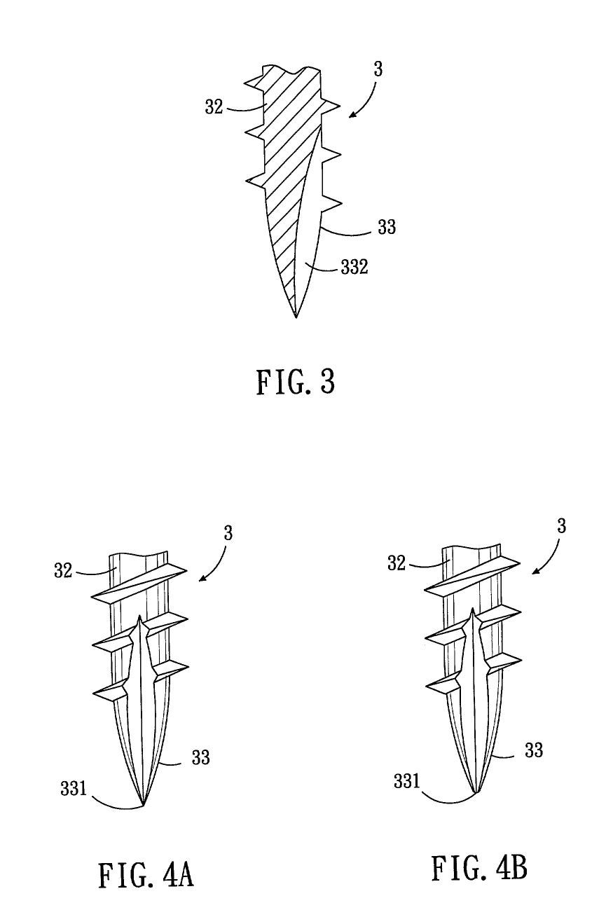

Referring to FIGS. 2 to 3, the first preferred embodiment of a screw 3 according to the present invention is shown to comprise a shank 32 having a head end part 31 and a tapered insert end part 33 opposite to the head end part 31 along an axis (Y) of the shank 32. The shank 32 further has a surface that is formed with a screw thread 321 that spirals downwardly along the axis (Y) of the shank 32 from one end of the shank 32 which is adjacent to the head end part 31 to the other end of the shank 32 which is adjacent to the insert end part 33. The insert end part 33 is formed with an insert tip 331, and has a surface that is free of the screw thread and that is formed with a flute 332. The insert tip 331 of the insert end part 33 can be a pointed tip (see FIG. 4A) or a rounded tip (see FIG. 4B). The flute 332 has an upper end portion 3321 and a lower end portion 3322, and extends parallel to the axis (Y) of the shank 32 in this embodiment. The upper end portion 3321 extends to interrupt a portion of the screw thread 321. The lower end portion 3322 is opposite to the upper end portion 3321. The flute 332 is defined by two confining side walls 3323 which extend radially from the axis (Y) of the shank 32 and which form an angle ranging from 90° to 180° therebetween. The upper and lower end portions 3321, 3322 of the flute 332 have a depth that gradually increases toward an intermediate portion of the flute 332. In this embodiment, the lower end portion 3322 of the flute 332 is coterminous with the insert tip 331 of the insert end part 33.

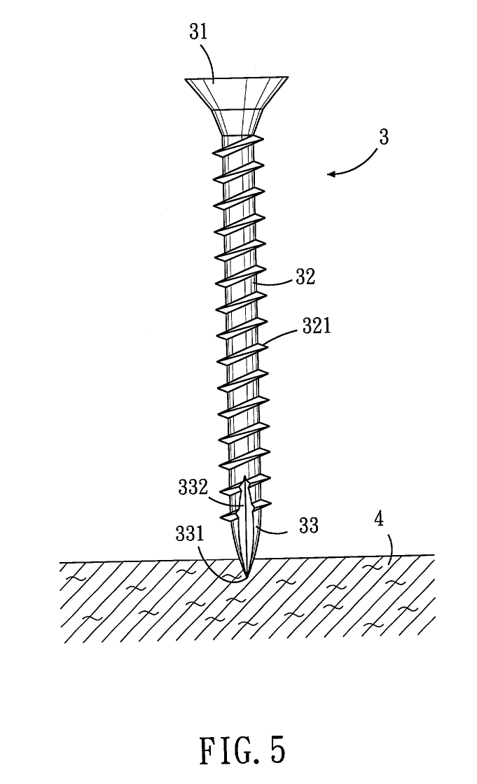

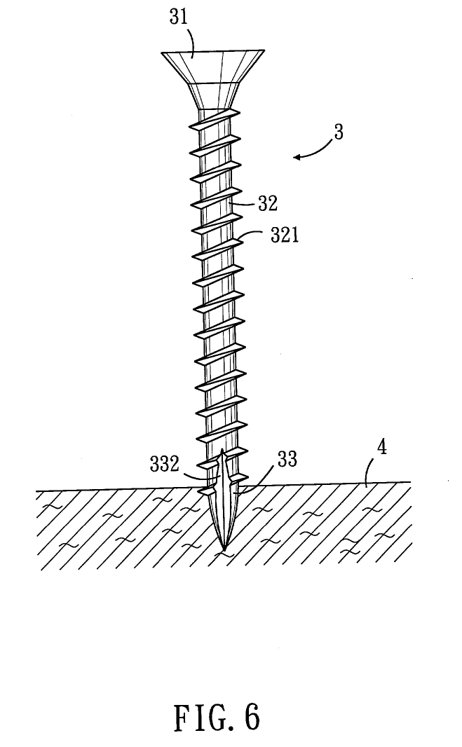

In use, after abutting the insert end part 33 of the screw 3 against a fibrous board 4 (see FIG. 5), a torque is applied on the head end part 31. The insert tip 331 pierces into the board 4 initially, and then guides the insert end part 33 gradually into the board 4 so as to form a bore in the board 4. At the same time, the flute 332 acts to discharge the shavings from the board 4. The screw thread 321 of the shank 32 is then driven rotatably into the board 4 after the insert end part 33 enters into the board 4, as best illustrated in FIG. 6. As such, driving movement of the screw thread 321 does not result in cracking of the surface of the fibrous board 4, thereby maintaining the appearance of the fibrous board 4.

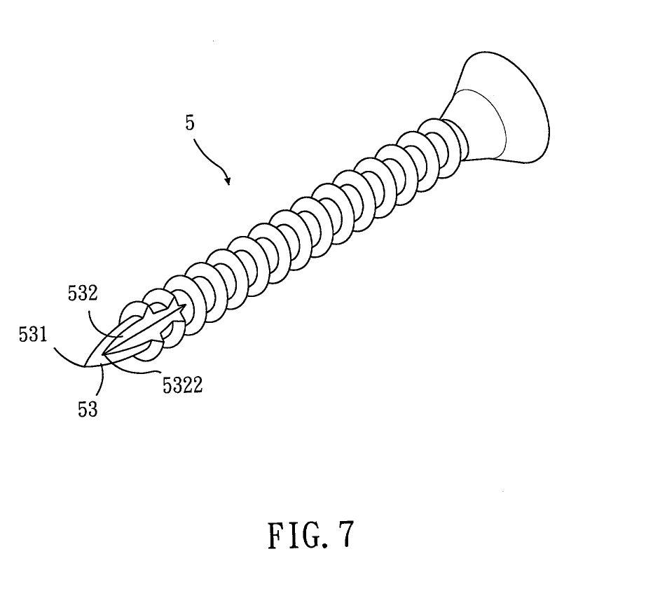

Referring to FIG. 7, the second preferred embodiment of a screw 5 according to the present invention is shown to be substantially similar to the first preferred embodiment, except that the lower end portion 5322 of the flute 532 is spaced apart from the insert tip 531 of the insert end part 53.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A screw comprising a shank having a head end part, and a tapered insert end part opposite to said head end part along an axis of said shank, said shank further having a surface that is formed with a screw thread that spirals downwardly along the axis of said shank from one end of said shank which is adjacent to said head end part to the other end of said shank which is adjacent to said insert end part, said insert end part being formed with an insert tip and having a surface formed with a flute, said flute having an upper end portion extending to interrupt a portion of said screw thread and a lower end portion opposite to said upper end portion, said flute being defined by two confining side walls which extend radially from the axis of said shank and which form an angle ranging from 90° to 180° therebetween, said upper and lower end portions of said flute having a depth that gradually increases toward an intermediate portion of said flute.

2. The screw as claimed in claim 1, wherein said insert tip of said insert end part is a pointed tip.

3. The screw as claimed in claim 1, wherein said insert tip of said insert end part is a rounded tip.

4. The screw as claimed in claim 1, wherein said lower end portion of said flute is spaced apart from said insert tip of said insert end part.

5. The screw as claimed in claim 1, wherein said lower end portion of said flute is coterminous with said insert tip of said insert end part.

6. The screw as claimed in claim 1, wherein said flute extends parallel to the axis of said shank.

7. The screw as claimed in claim 1, wherein said insert end part has a surface that is free of the screw thread.
